(19) United States
(12) Patent Application Publication
(10) Pub. No.: US 2025/0386757 A1
(43) Pub. Date: Dec. 25, 2025

(54) PIEZOELECTRIC DEVICE TUNED FOR ENERGY HARVESTING ACROSS A FREQUENCY RANGE

(71) Applicant: Deere & Company, Moline, IL (US)

(72) Inventors: Mark E. Barker, Johnston, IA (US); Christopher T. Boyle, Johnston, IA (US)

(21) Appl. No.: 18/753,028

(22) Filed: Jun. 25, 2024

(51) Int. Cl. A01B 71/02; A01B 63/00; A01B 71/06; A01B 76/00

(52) U.S. Cl. CPC A01B 71/02; A01B 63/008; A01B 71/06; A01B 76/00

(57) ABSTRACT

A method for monitoring a ground engaging tool of an implement of a work vehicle. The method comprises providing a first piezoelectric device comprising a first mass positioned at a first position, adjusting at least one of the first mass and the first position to provide a power output at a first end of a frequency range, providing a second piezoelectric device comprising a second mass positioned at a second position, the second piezoelectric device electrically coupled to the first piezoelectric device for providing the power output, adjusting at least one of the second mass and the second position to provide the power output at a second end of the frequency range, providing a signal indicative of a status of the ground engaging tool, and determining whether to stop the work vehicle or change a setting and stopping the work vehicle or changing the setting.

### TECHNICAL FIELD

The present disclosure relates generally to a work vehicle and a method for monitoring a component or a ground engaging tool of an implement of the work vehicle.

### BACKGROUND

In order to verify that a ground engaging tool is operating properly, an operator commonly has to visually inspect each ground engaging tool. For example, an operator would need to stop the agricultural or construction implement and check each ground engaging tool to ensure that it is not tripped, broken, or missing.

### SUMMARY

In one embodiment, a method for monitoring a ground engaging tool of an implement of a work vehicle is disclosed. The method comprises providing a first piezoelectric device on the implement, the first piezoelectric device comprising a first mass positioned at a first position, adjusting at least one of the first mass and the first position to provide a power output at a first end of a frequency range, providing a second piezoelectric device on the implement, the second piezoelectric device comprising a second mass positioned at a second position, the second piezoelectric device electrically coupled to the first piezoelectric device for providing the power output, adjusting at least one of the second mass and the second position to provide the power output at a second end of the frequency range, providing a signal indicative of a status of the ground engaging tool using the power output, and utilizing the signal to determine whether to stop the work vehicle or change a setting of the work vehicle or implement due to a ground engaging tool issue and stopping the work vehicle or changing the setting if so determined.

In another embodiment, a work vehicle configured to move an implement is disclosed. The work vehicle comprises a work vehicle frame. At least one ground engaging device is coupled to the work vehicle frame and configured to support the work vehicle frame above a surface. An implement is coupled to the work vehicle, the implement comprises a ground engaging tool. A sensor is positioned adjacent the ground engaging tool, the sensor configured for providing a signal indicative of a ground engaging tool status. A power supply is coupled to the implement and electrically coupled to the sensor for providing power thereto, the power supply comprises a first piezoelectric device comprising a first mass positioned at a first position, at least one of the first mass and the first position adjusted to provide a power output at a first end of a frequency range, and a second piezoelectric device comprising a second mass positioned at a second position, the second piezoelectric device electrically coupled to the first piezoelectric device for providing the power output, at least one of the second mass and the second position adjusted to provide the power output at a second end of the frequency range. A controller is communicatively coupled to the sensor, the controller comprising a data storage device and an electronic data processor, the data storage device configured for storing instructions that are executable by the electronic data processor to cause the electronic data processor to receive the signal indicative of the ground engaging tool status, and determine whether to stop the work vehicle or change a setting of the work vehicle or implement due to a ground engaging tool issue and stopping the work vehicle or changing the setting if so determined.

In yet another embodiment, an implement for a work vehicle is disclosed. The implement comprises a frame. A ground engaging tool is coupled to the frame, the ground engaging tool is configured to engage a surface. A sensor is positioned adjacent the ground engaging tool, the sensor is configured for providing a signal indicative of a ground engaging tool status. A power supply is coupled to the implement and electrically coupled to the sensor for providing power thereto, the power supply comprises a first piezoelectric device comprising a first mass positioned at a first position, at least one of the first mass and the first position adjusted to provide a power output at a first end of a frequency range, and a second piezoelectric device comprising a second mass positioned at a second position, the second piezoelectric device electrically coupled to the first piezoelectric device for providing the power output, at least one of the second mass and the second position adjusted to provide the power output at a second end of the frequency range. A controller is communicatively coupled to the sensor, the controller comprising a data storage device and an electronic data processor, the data storage device configured for storing instructions that are executable by the electronic data processor to cause the electronic data processor to receive the signal indicative of the ground engaging tool status, and determine whether to stop the work vehicle or change a setting of the work vehicle or implement due to a ground engaging tool issue and stopping the work vehicle or changing the setting if so determined.

Other features and aspects will become apparent by consideration of the detailed description, claims, and accompanying drawings.

### BRIEF DESCRIPTION OF THE DRAWINGS

The detailed description of the drawings refers to the accompanying figures.

FIG. 1 is a perspective view of a work vehicle including an implement according to one embodiment.

FIG. 2 is a perspective view of a work vehicle including an implement according to another embodiment.

FIG. 3 is a perspective view of a work vehicle including an implement according to yet another embodiment.

FIG. 4 is a schematic of a work vehicle with an implement.

FIG. 5 is a perspective view of a first piezoelectric device and a second piezoelectric device.

FIG. 6 is a top view of a first piezoelectric device and a power storage.

FIG. 7 is a flow chart of a method for filling a fluid of a work vehicle.

Like reference numerals are used to indicate like elements throughout the several figures.

### DETAILED DESCRIPTION

As used herein, “e.g.” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

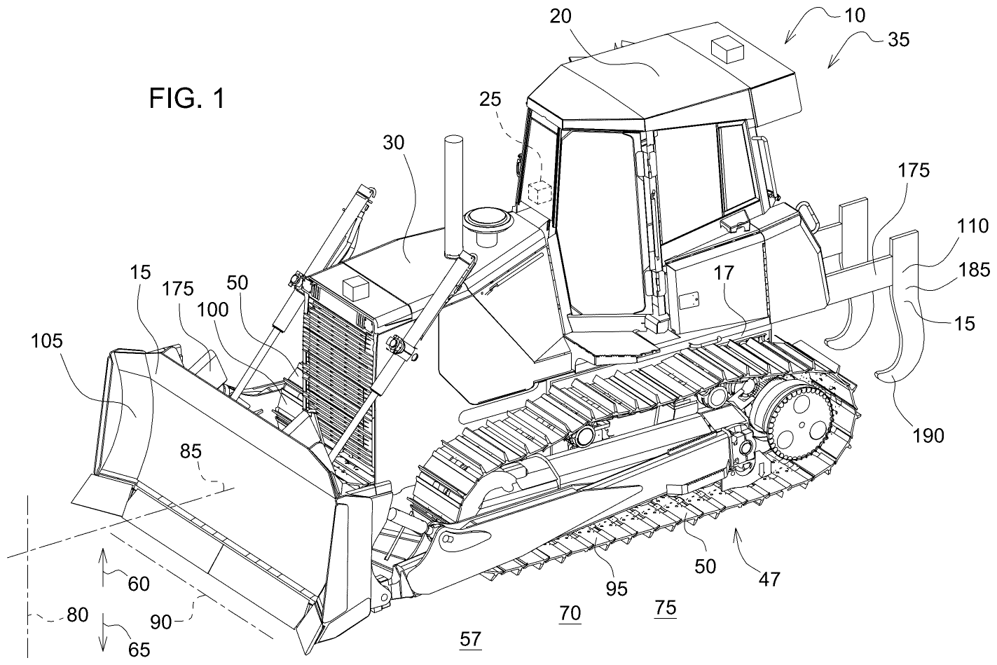

FIGS. 1-3 illustrate a work vehicle 10 configured to move an implement 15, a frame 17, an operator station 20 having an operator interface 25, and an engine 30. The work vehicle 10 may be any work vehicle 10 to which the implement 15 may be coupled for movement with the work vehicle 10, such as a crawler 35, a motor grader 40, or a tractor 45 to name a few examples. The implement 15 may be attached directly to the work vehicle 10 or towed behind the work vehicle 10. The work vehicle 10 may be controlled by an operator located in the operator station 20 or by an operator located at a remote location (not shown) from the work vehicle 10. The operator may command the work vehicle 10 to move forward, move backward, and turn. Those commands are sent to hydraulic pumps, driven by the engine 30, which direct pressurized hydraulic fluid to hydraulic motors that turn at least one ground engaging device 47, such as tracks 50 or wheels 55, that support the frame 17 above a surface 57. The engine 30 may be a diesel engine. Alternatively, the tracks 50 or wheels 55 may be turned by electric motors.

Referring to FIG. 1, the implement 15 may be positioned at a front of the work vehicle 10 and may be attached to the work vehicle 10 in a number of different manners. In this embodiment, the implement 15 may be attached to the work vehicle 10 through a linkage which includes a series of pinned joints, structural members, and hydraulic cylinders. This configuration allows the implement 15 to be moved up 60 and down 65 relative to a ground material 70 of a worksite 75 or the surface 57, rotate around a vertical axis 80 (i.e., an axis normal to the ground), rotate around a longitudinal axis 85 (e.g., a fore-aft axis of the work vehicle 10), and rotate around a lateral axis 90 of the work vehicle 10 (i.e., a left-right axis of the work vehicle 10). These degrees of freedom permit the implement 15 to engage the ground material 70 at multiple depths and cutting angles. Alternative embodiments may involve implements 15 with greater degrees of freedom, such as those found on some motor graders 40, and those with fewer degrees of freedom, such as “pushbeam” style blades found on some crawlers 35 and implements 15 which may only be raised, lowered, and rotated around a vertical axis as found on some excavators and skidders, and implements 15 that are attached to other locations of the work vehicle 10 (e.g., rear).

The operator may command movement of the implement 15 from the operator station 20, which may be coupled to the work vehicle 10 or located remotely. In the case of the work vehicle 10, those commands are sent, including mechanically, hydraulically, and/or electrically, to a hydraulic control valve. The hydraulic control valve receives pressurized hydraulic fluid from a hydraulic pump, and selectively sends such pressurized hydraulic fluid to a system of hydraulic cylinders based on the operator's commands. The hydraulic cylinders, which in this case are double-acting, in the system are extended or retracted by the pressurized fluid and thereby actuate the implement 15. Alternatively, electronic actuators may be used.

With continued reference to FIG. 1, the illustrated work vehicle 10 is a crawler 35 for moving the ground material 70. The crawler 35 includes tracks 50 including a left track 95 and a right track 100. As used herein, “left” and “right” refer to the left and right sides of the operator when the operator is sitting within the operator station 20 that is coupled to the work vehicle 10 and facing the illustrated implement 15. The illustrated implement 15 is a blade 105. Alternatively, it is contemplated that the implement 15 may be a bucket (not shown) or other attachment coupled to a wheel loader (not shown). One such implement 15 is a ripper 110 that is attached to a rear of the work vehicle 10 via a frame 175 of the implement 15. The ripper 110 is a ground engaging tool 185 that comprises a ripper shank 190.

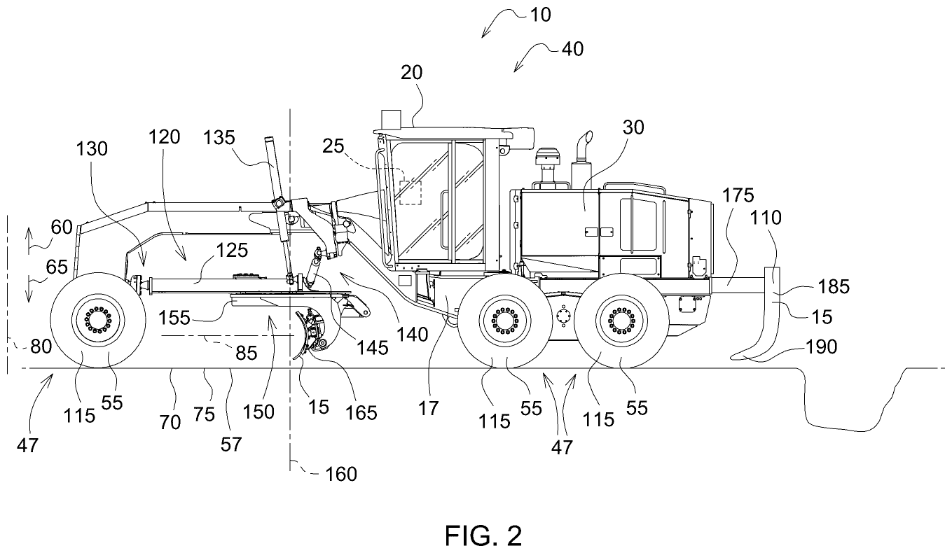

Referring to FIG. 2, the illustrated work vehicle 10 is a motor grader 40 for spreading and leveling dirt, gravel, or other ground material 70. The motor grader 40 includes wheels 55 including a plurality of left wheels 115 (right wheels not shown). A drawbar assembly 120 or draft frame is coupled to the work vehicle 10. A drawbar 125 of the drawbar assembly 120 is mounted to a front location 130 of the work vehicle 10. Left and right actuators 135 support the drawbar 125. The left and right actuators 135 either raise or lower the drawbar 125. A side shift linkage arrangement 140 is coupled to the drawbar 125 and includes a side swing hydraulic actuator 145.

A circle drive assembly 150, or frame 175, is coupled to the drawbar assembly 120. The circle drive assembly 150 can include a rotatable circle member 155 coupled to the draft frame or drawbar assembly 120. The circle drive assembly 150 can be rotatable about a rotation axis 160 in a clockwise or counterclockwise direction.

The illustrated implement 15 is a moldboard 165 that is coupled to the circle drive assembly 150 of the work vehicle 10 and configured to move the ground material 70 on the worksite 75. While a moldboard 165 is described herein, other types of implements 15 are contemplated by this disclosure. For example, a ripper 110 is attached to a rear, opposite of the front location 130, of the work vehicle 10. The ripper 110 is a ground engaging tool 185 that comprises a ripper shank 190.

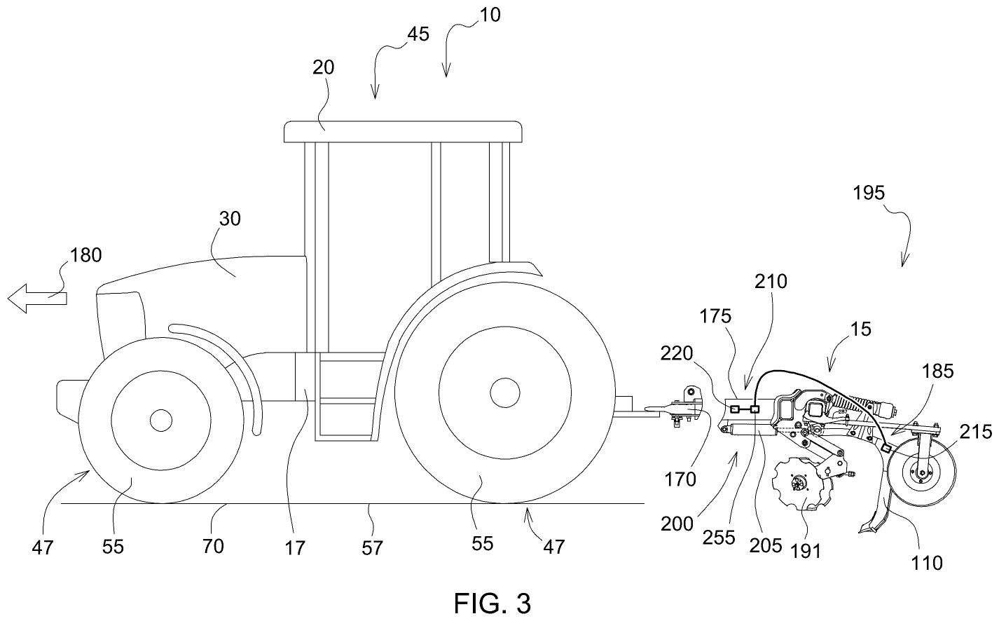

FIG. 3 illustrates a work vehicle 10 having an implement 15 according to another embodiment. The illustrated work vehicle 10 is an agricultural tractor 45. The illustrated implement 15 is a tillage implement 195.

The tillage implement 195 includes a coupling mechanism 170 for coupling to the work vehicle 10. The frame 175 is coupled to the coupling mechanism 170. The frame 175 extends rearwardly from the coupling mechanism 170 in a direction opposite of a direction of travel 180. A ground-engaging tool 185 is coupled to the frame 175. Additional ground-engaging tools 185 may be coupled to the frame 175. The illustrated ground-engaging tool 185 is the ripper 110. Other ground-engaging tools 185 (e.g., disks, openers) are contemplated by this disclosure including a tillage shank 187, a rolling basket, and a disk 195. A plurality of wheel assemblies (not shown) are coupled to the frame 175 to support the frame 175 above the ground material 70.

An adjustment device 200 is coupled to the ground-engaging tool 185. The illustrated adjustment device 200 is an extendable and retractable hydraulic actuator 205. Alternatively, the adjustment device 200 may be an electric actuator, pneumatic cylinder, or other similar device. Additional adjustment devices 200 may be coupled to additional ground-engaging tools 185 for individual control thereof.

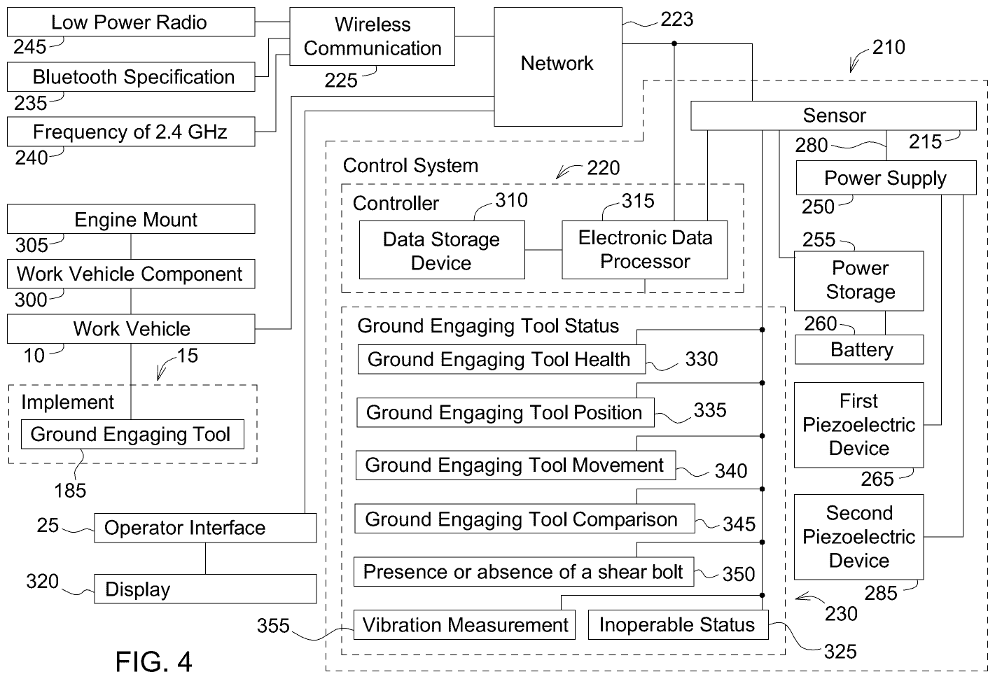

With continued reference to FIG. 3 and reference to FIG. 4, a control system 210 is provided. The control system 210 comprises a sensor 215 and a controller 220 that communicate with each other via a network 223 including at least one of a wired or wireless communication 225 and may control or change settings on the work vehicle 10. In one embodiment, the sensor 215 may be positioned adjacent or near the ground engaging tool 185 and is configured to provide a signal indicative of a ground engaging tool status 230 to the controller 220. Alternatively, the sensor 215 may be coupled to the ground engaging tool 185 or positioned elsewhere on the work vehicle 10. The sensor 215 may be a camera, a lidar, a radar, a vibration sensor, a mechanical sensor, or other type of sensor 215 that is positioned near or has a view of the ground engaging tool 185. The sensor 215 may communicate with the controller 220 via the network 223 by employing the wireless communication 225 in accordance with a Bluetooth specification 235, or a frequency of 2.4 GHz 240, or by way of a low power radio 245.

The sensor 215 is electrically coupled to a power supply 250 and/or a power storage 255 or battery 260 configured for providing electrical power to the sensor 215. The power storage 255 may be configured to be charged by the power supply 250 coupled to the agricultural or construction implement 15. The battery 260 may also be charged by the work vehicle 10 electrical system or by other means.

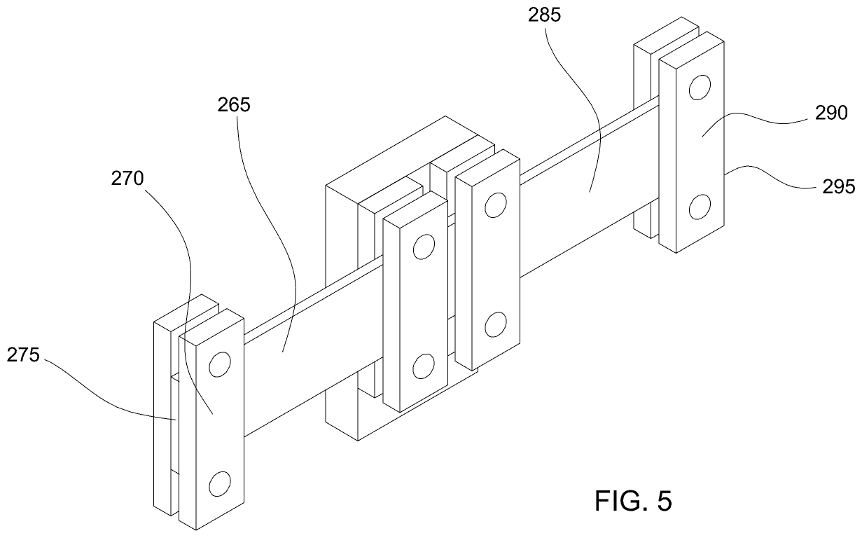

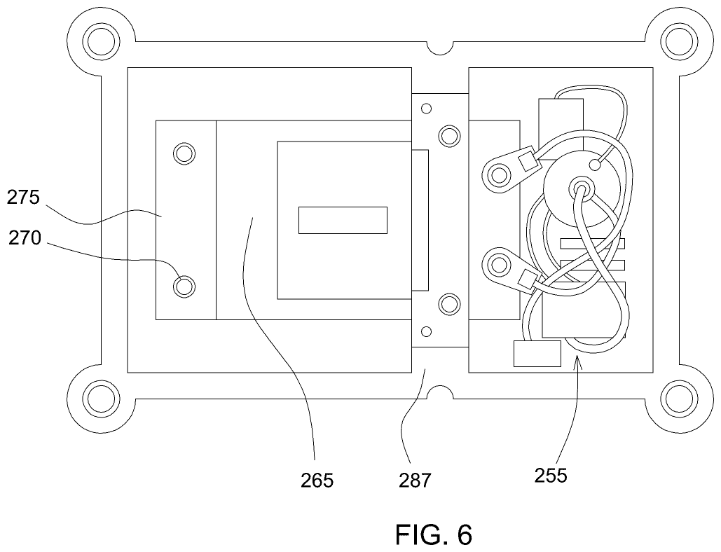

Referring to FIGS. 4-6, the power supply 250 may comprise a first piezoelectric device 265 comprising a first mass 270 positioned at a first position 275. At least one of the first mass 270 and the first position 275 may be adjusted to provide a power output 280 at a first end of a frequency range. A second piezoelectric device 285 may comprise a second mass 290 positioned at a second position 295. The second piezoelectric device 285 may be electrically coupled to the first piezoelectric device 265 for providing the power output 280. At least one of the second mass 290 and the second position 295 may be adjusted to provide the power output 280 at a second end of the frequency range. The first piezoelectric device 265 and the second piezoelectric device 285 may be electrically coupled in series or in parallel. More than two piezoelectric devices may also be used. The piezoelectric devices may also be contained in an enclosure 287 (FIG. 6). The frequency range may, for example, be 20-30 Hz. In this example, the first end of the frequency range is 20 Hz and the second end of the frequency range is 30 Hz. The first piezoelectric device 265 may be tuned for 20 Hz and the second piezoelectric device 285 may be tuned for 30 Hz. This improves the overall power output 280 for the full range of the frequency range that is experienced by the power supply 250 in this embodiment. This also improves the optimal power output at resonance at either end of the frequency range. This is important for situations that include varying speeds and random vibrations, and thus experience a range of frequencies, such as on the work vehicle 10. For other embodiments, for example monitoring another work vehicle component 300 such as an engine mount 305, the frequency range may vary and the first piezoelectric device 265 and the second piezoelectric device 285 may be tuned for different frequencies than the example frequencies provided above.

The controller 220 comprises a data storage device 310 and an electronic data processor 315. The data storage device 310 is configured for storing instructions that are executable by the electronic data processor 315 to cause the electronic data processor 315 to receive the signal indicative of the ground engaging tool status 230, determine the ground engaging tool status 230, and provide a signal indicative of the ground engaging tool status 230 to an operator via the operator interface 25, or a display 320, or to change an operation of the implement 15 and/or work vehicle 10, or automatically change an implement setting or to stop the implement 15 and/or work vehicle 10. The operation or implement setting may be the speed with which the implement 15 is moving with the work vehicle 10, an operating height of the implement 15 relative to the ground material 70 of a worksite 75, a depth of the ground engaging tool 185 in the ground material 70, the position of the adjustment device 200, the position of the circle drive assembly 150, the position of the side shift linkage arrangement 140, the position of the left and right actuators 135, the position of the ripper 110, the position of the blade 105, the position of the moldboard 165, or the direction of travel 180 of the work vehicle 10.

Although the controller 220 is referenced in the singular, in alternative embodiments the configuration and functionality described herein can be split across multiple devices using techniques known to a person of ordinary skill in the art. The controller 220 includes the data storage device 310 that includes the tangible, non-transitory memory on which are recorded computer-executable instructions. The controller 220 may be embodied as one or multiple digital computers or host machines each having one or more electronic data processors 315, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and any required input/output (I/O) circuitry, I/O devices, and communication interfaces, as well as signal conditioning and buffer electronics. As used herein, “controller” is intended to be used consistent with how the term is used by a person of skill in the art, and refers to a computing component with processing, memory, and communication capabilities, which is utilized to execute instructions (i.e., stored on the memory or received via the communication capabilities) to control or communicate with one or more other components. In certain embodiments, the controller 220 may be configured to receive input signals in various formats (e.g., hydraulic signals, voltage signals, current signals, CAN messages, optical signals, radio signals), and to output command or communication signals in various formats (e.g., hydraulic signals, voltage signals, current signals, CAN messages, optical signals, radio signals).

In operation, if the electronic data processor 315 determines that the ground engaging tool status 230 is that the agricultural or construction implement 15 is an inoperable status 325, the electronic data processor 315 may provide a signal to the work vehicle 10 to stop the agricultural or construction implement 15 from operating.

The ground engaging tool status 230 comprises at least one of a ground engaging tool health 330, a ground engaging tool position 335, a ground engaging tool movement 340, or a ground engaging tool comparison 345. The ground engaging tool status 230 also may comprise the presence or absence of a shear bolt 350 or a vibration measurement 355.

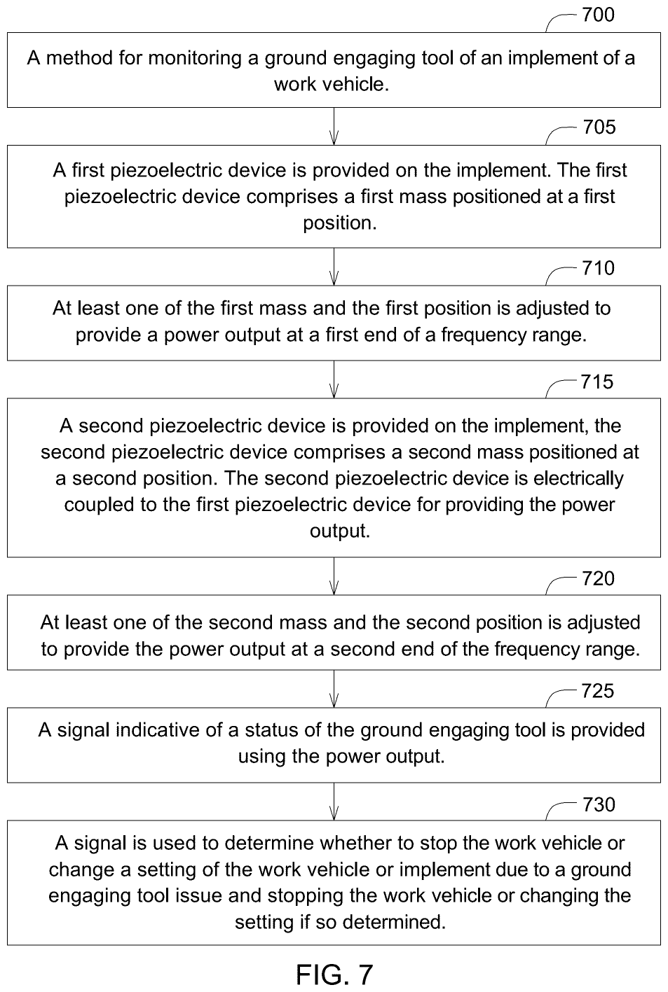

Referring now to FIG. 7, a flow diagram of a method 700 for monitoring a ground engaging tool of an implement of a work vehicle is provided. At 705, a first piezoelectric device is provided on the implement. The first piezoelectric device comprises a first mass positioned at a first position. At 710, at least one of the first mass and the first position is adjusted to provide a power output at a first end of a frequency range. At 715, a second piezoelectric device is provided on the implement, the second piezoelectric device comprises a second mass positioned at a second position. The second piezoelectric device is electrically coupled to the first piezoelectric device for providing the power output. At 720, at least one of the second mass and the second position is adjusted to provide the power output at a second end of the frequency range. At 725, a signal indicative of a status of the ground engaging tool is provided using the power output. At 730, the signal is used to determine whether to stop the work vehicle or change a setting of the work vehicle or implement due to a ground engaging tool issue and stopping the work vehicle or changing the setting if so determined.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A method for monitoring a ground engaging tool of an implement of a work vehicle, the method comprising:
providing a first piezoelectric device on the implement, the first piezoelectric device comprising a first mass positioned at a first position;
adjusting at least one of the first mass and the first position to provide a power output at a first end of a frequency range;
providing a second piezoelectric device on the implement, the second piezoelectric device comprising a second mass positioned at a second position, the second piezoelectric device electrically coupled to the first piezoelectric device for providing the power output;
adjusting at least one of the second mass and the second position to provide the power output at a second end of the frequency range;
providing a signal indicative of a status of the ground engaging tool using the power output; and
utilizing the signal to determine whether to stop the work vehicle or change a setting of the work vehicle or implement due to a ground engaging tool issue and stopping the work vehicle or changing the setting if so determined.

2. The method of claim 1, wherein the signal is provided by employing a wireless communication.

3. The method of claim 2, wherein the wireless communication has a frequency of 2.4 GHz.

4. The method of claim 3, wherein the wireless communication is in accordance with a Bluetooth specification.

5. The method of claim 1, further comprising a power storage electrically coupled to the first piezoelectric device and the second piezoelectric device.

6. The method of claim 1, wherein the ground engaging tool comprises a tillage tool.

7. The method of claim 2, wherein the wireless communication comprises a low power radio.

8. A work vehicle configured to move an implement, the work vehicle comprising:
a work vehicle frame;
at least one ground engaging device coupled to the work vehicle frame and configured to support the work vehicle frame above a surface;
an implement coupled to the work vehicle, the implement comprising a ground engaging tool;
a sensor positioned adjacent the ground engaging tool, the sensor configured for providing a signal indicative of a ground engaging tool status;
a power supply coupled to the implement and electrically coupled to the sensor for providing power thereto, the power supply comprising:
a first piezoelectric device comprising a first mass positioned at a first position, at least one of the first mass and the first position adjusted to provide a power output at a first end of a frequency range, and
a second piezoelectric device comprising a second mass positioned at a second position, the second piezoelectric device electrically coupled to the first piezoelectric device for providing the power output, at least one of the second mass and the second position adjusted to provide the power output at a second end of the frequency range, and
a controller communicatively coupled to the sensor, the controller comprising a data storage device and an electronic data processor, the data storage device configured for storing instructions that are executable by the electronic data processor to cause the electronic data processor to:
receive the signal indicative of the ground engaging tool status, and
determine whether to stop the work vehicle or change a setting of the work vehicle or implement due to a ground engaging tool issue and stopping the work vehicle or changing the setting if so determined.

9. The work vehicle of claim 8, further comprising a power storage electrically coupled to the power supply.

10. The work vehicle of claim 8, wherein the work vehicle comprises a tractor.

11. The work vehicle of claim 8, wherein the implement comprises a tillage implement and the ground engaging tool comprises a tillage shank or a disk.

12. The work vehicle of claim 8, wherein the first piezoelectric device and the second piezoelectric device are electrically coupled in series or parallel.

13. An implement for a work vehicle, the implement comprising:
a frame;
a ground engaging tool coupled to the frame, the ground engaging tool configured to engage a surface;
a sensor positioned adjacent the ground engaging tool, the sensor configured for providing a signal indicative of a ground engaging tool status;
a power supply coupled to the implement and electrically coupled to the sensor for providing power thereto, the power supply comprising:
a first piezoelectric device comprising a first mass positioned at a first position, at least one of the first mass and the first position adjusted to provide a power output at a first end of a frequency range, and
a second piezoelectric device comprising a second mass positioned at a second position, the second piezoelectric device electrically coupled to the first piezoelectric device for providing the power output, at least one of the second mass and the second position adjusted to provide the power output at a second end of the frequency range, and
a controller communicatively coupled to the sensor, the controller comprising a data storage device and an electronic data processor, the data storage device configured for storing instructions that are executable by the electronic data processor to cause the electronic data processor to:
receive the signal indicative of the ground engaging tool status, and
determine whether to stop the work vehicle or change a setting of the work vehicle or implement due to a ground engaging tool issue and stopping the work vehicle or changing the setting if so determined.

14. The implement of claim 13, wherein the implement is coupled to the work vehicle for movement and if the data processor determines that the ground engaging tool status is an inoperable status, the electronic data processor provides a signal to the work vehicle to stop the implement from operating.

15. The implement of claim 13, wherein the implement comprises a tillage implement and the ground engaging tool comprises a tillage shank, a rolling basket, or a disk.

16. The implement of claim 13, wherein the work vehicle comprises a motor grader, the implement comprises a ripper, and the ground engaging tool comprises a ripper shank.

17. The implement of claim 13, wherein the ground engaging tool status comprises the presence or absence of a shear bolt.

18. The implement of claim 13, wherein the sensor communicates with the controller via at least one of a wired or wireless communication.

19. The implement of claim 13, wherein the signal is provided by employing a wireless communication in accordance with a Bluetooth specification.

20. The implement of claim 13, further comprising a power storage electrically coupled to the power supply.
